(19) United States
(12) Patent Application Publication
(10) Pub. No.: US 2025/0238970 A1
(43) Pub. Date: Jul. 24, 2025

(54) IMAGE PROCESSING APPARATUS CAPABLE OF PROPERLY PROVIDING INSTRUCTION FOR IMAGE GENERATION TO GENERATIVE ARTIFICIAL INTELLIGENCE, METHOD OF CONTROLLING IMAGE PROCESSING APPARATUS, AND STORAGE MEDIUM

(71) Applicant: CANON KABUSHIKI KAISHA, Tokyo (JP)

(72) Inventor: XIAOLI WANG, Tokyo (JP)

(21) Appl. No.: 18/956,101

(22) Filed: Nov. 22, 2024

(30) Foreign Application Priority Data
Jan. 23, 2024 (JP) 2024-007900

(51) Int. Cl. G06T 11/00; G06V 10/77

(52) U.S. Cl. CPC G06T 11/00; G06V 10/77; G06T 2211/441

(57) ABSTRACT

An information processing apparatus capable of properly providing an instruction for image generation to a generative artificial intelligence (AI). A scanner unit reads an original. A controller causes the generative AI to generate, based on scan image data acquired by reading the original by the scanner unit, AI image data. The controller receives the second image data generated by the generative AI.

### BACKGROUND OF THE INVENTION

### CROSS-REFERENCE TO PRIORITY APPLICATION

This application claims the benefit of Japanese Patent Application No. 2024-007900 filed Jan. 23, 2024, which is hereby incorporated by reference herein in its entirety.

### FIELD OF THE INVENTION

The present invention relates to an image processing apparatus capable of properly providing an instruction for image generation to a generative artificial intelligence, a method of controlling the image processing apparatus, and a storage medium.

### DESCRIPTION OF THE RELATED ART

An AI-Generated Content (AIGC) system is known which generates an image using key words input by a user. To the AIGC system, as keywords, for example, a prompt formed by a character string of natural language is input (see US20230267652A1). The AIGC system generates an image including an object associated with the prompt input by the user. This enables the user to acquire, only by inputting a prompt to the AIGC system, an image including an object associated with the prompt, such a person or an automotive vehicle.

However, with a configuration in which the afore mentioned prompt is used as an instruction for image generation, it is sometimes impossible to properly provide an instruction concerning a composition including a direction in which a person faces, or an instruction concerning the background.

### SUMMARY OF THE INVENTION

The present invention provides an information processing apparatus capable of properly providing an instruction for image generation to a generative artificial intelligence.

In a first aspect of the invention, there is provided an image processing apparatus including a reading unit configured to read an original, a generation unit configured to cause generative AI to generate, based on first image data acquired by reading the original by the reading unit, second image data, and a reception unit configured to receive the second image data generated by the generative AI.

In a second aspect of the invention, there is provided a method of controlling an image processing apparatus, including reading an original, causing generative AI to generate, based on first image data acquired by reading the original by the reading, second image data, and receiving the second image data generated by the generative AI.

According to the present invention, it is possible to properly provide an instruction for image generation to a generative artificial intelligence.

Further features of the present invention will become apparent from the following description of exemplary embodiments (with reference to the attached drawings).

### BRIEF DESCRIPTION OF THE DRAWINGS

FIG. 1 is a configuration diagram schematically showing a configuration of an AIGC system including an image processing apparatus according to an embodiment of the present invention.

FIG. 2 is a block diagram schematically showing a configuration of a controller appearing in FIG. 1.

FIG. 3 is a block diagram schematically showing a configuration of a generative AI server appearing in FIG. 1.

FIG. 4 is a diagram useful in explaining a process performed by using AI image data received by the image processing apparatus appearing in FIG. 1 from the generative AI server.

FIG. 5 is a diagram showing an example of a user interface (UI) image screen

displayed on a console section appearing in FIG. 1.

FIG. 6 is a diagram showing an example of a setting screen displayed on the operation section appearing in FIG. 1.

FIGS. 7A and 7B are diagrams useful in explaining setting of operation buttons in the setting screen appearing in FIG. 6.

FIG. 8 is a flowchart of an AI image data generation control process performed by the image processing apparatus appearing in FIG. 1.

FIG. 9 is a diagram useful in explaining details of steps of the AI image data generation control process shown in FIG. 8.

### DESCRIPTION OF THE EMBODIMENTS

The present invention will now be described in detail below with reference to the accompanying drawings showing embodiments thereof. The embodiments of the invention, described below, are not intended to limit the invention recited in the appended claims, and all combination of features described in the embodiments are not essential to the solution of the present invention.

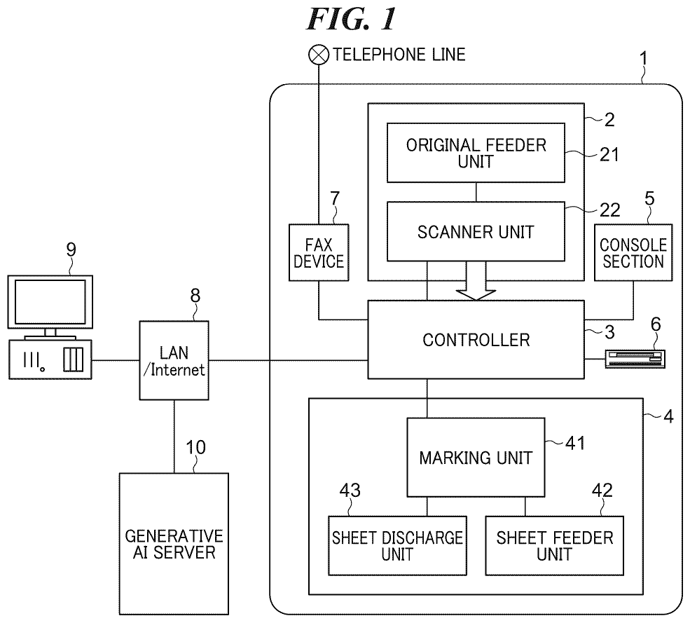

FIG. 1 is a configuration diagram schematically showing a configuration of an AI-Generated Content (AIGC) system including an image processing apparatus 1 according to an embodiment of the present embodiment. AI is short for Artificial Intelligence. In FIG. 1, the AIGC system is comprised of the image processing apparatus 1, a computer 9, and a generative AI server 10. The image processing apparatus 1, the computer 9, and the generative AI server 10 can communicate with each other via a LAN/Internet 8. In the AIGC system, the image processing apparatus 1 reads an original of a rough drawing in which an object is roughly hand-drawn by the user and generates digital image data of the original (hereafter referred to as “the scan image data”). The image processing apparatus 1 transmits an image generation request based on the scan image data to the generative AI server 10. The generative AI server 10 includes a generative AI that generates colored realistic image data (hereinafter referred to as the AI image data) according to the received image generation request. The generative AI server 10 transmits the generated AI image data to a transmission destination designated by the image generation request, such as the image processing apparatus 1 or the computer 9.

Next, the configuration of the image processing apparatus 1 will be described. Referring to FIG. 1, the image processing apparatus 1 includes a scanner device 2, a controller 3, a printer device 4, a console section 5, a storage device 6, and a FAX device 7. The controller 3 is connected to the scanner device 2, the printer device 4, the console section 5, the storage device 6, and the FAX device 7, respectively.

The scanner device 2 includes an original feeder unit 21 in which a set of originals can be automatically set in a fashion replaceable by another as desired, and a scanner unit 22 that can optically scan each original to form scan image data. The scanner device 2 optically reads an image from an original, converts the read image into scan image data, and transmits the scan image data to the controller 3.

The controller 3 executes a job by issuing respective instructions to modules connected thereto. The printer device 4 prints image data on a sheet. The printer device 4 includes a sheet feeder unit 42 that feeds sheets one by one from a set of sheets, a marking unit 41 for printing image data on a sheet fed by the sheet feeder unit 42, and a sheet discharge unit 43 for discharging a printed sheet.

The console section 5 receives a variety of instructions from a user, and displays a variety of information on the image processing apparatus 1. The storage device 6 stores image data, control programs, and so forth. The FAX device 7 transmits scan image data and the like to an external apparatus via a telephone line or the like.

The image processing apparatus 1 transmits and receives image data to and from the computer 9 via the LAN/Internet 8. Further, the image processing apparatus 1 receives, via the LAN/Internet 8, a job issuing instruction and the like transmitted from the computer 9.

Further, the computer 9 controls the operation of the image processing apparatus 1 via the LAN/Internet 8. For example, the computer 9 outputs a power off instruction to the controller 3 of the image processing apparatus 1 via the LAN/Internet 8. The controller 3 controls power off sequence of the image processing apparatus 1 according to the received power off instruction.

The image processing apparatus 1 is equipped with a plurality of functions including a copy function, an image transmission function, an image storage function, an image printing function. The copy function is a function of storing scan image data generated by the scanner device 2 that performs optical scanning of an original, in the storage device 6, and printing the scan image data by the printer device 4. The image transmission function is a function of transmitting scan image data generated by the scanner device 2 that performs optical scanning of an original to an external apparatus, such as the computer 9, via the LAN/Internet 8. The image storage function is a function of storing scan image data generated by the scanner device 2 that performs optical scanning of an original, in the storage device 6, and performs transmission or printing of the scan image data, as required. The image printing function is a function of causing the printer device 4 to execute print processing by analyzing PDL data transmitted from the computer 9.

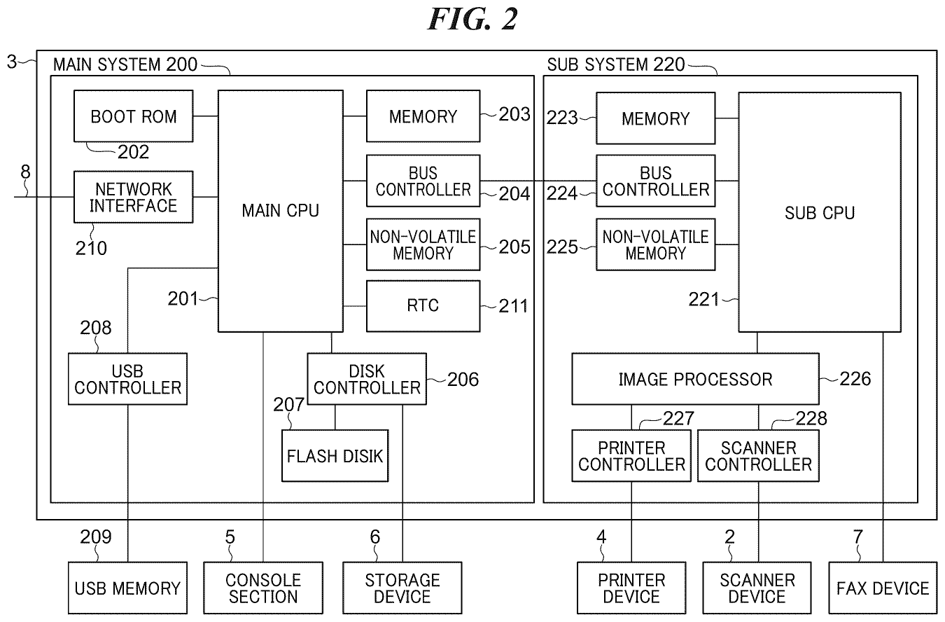

Next, the configuration of the controller 3 of the image processing apparatus 1 will be described. FIG. 2 is a block diagram schematically showing the configuration of the controller 3 appearing in FIG. 1. Referring to FIG. 2, the controller 3 is formed by a main system 200 and a sub system 220.

Connected to the main system 200 are a universal serial bus (USB) memory 209, the console section 5, the storage device 6, and so forth. The main system 200 is a so-called general-purpose central processing unit (CPU) system. The main system 200 includes a main CPU 201, a boot rom 202, a memory 203, a bus controller 204, a non-volatile memory 205, and a disk controller 206. The main system 200 further includes a flash disk 207, a USB controller 208, a network interface 210, and a real-time clock (RTC) 211.

The main CPU 201 controls the entirety of the main system 200. The boot rom 202 stores a boot program. The memory 203 is used as a work memory of the main CPU 201. The bus controller 204 has a bridge function with an external bus. The non-volatile memory 205 is a storage device capable of storing data even after the main system 200 is powered off. The disk controller 206 controls storage devices, including the flash disk 207 and the storage device 6. The flash disk 207 is a non-volatile storage device having a relatively small capacity, which is formed by a semiconductor device, for example, a solid state drive (SSD). The USB controller 208 controls a USB device connected to the image processing apparatus 1. For example, the USB controller 208 performs processing for storing image data in the USB memory 209 connected to the image processing apparatus 1 and processing for reading image data stored in the USB memory 209. The network interface 210 performs data communication with external apparatuses including the computer 9 and the generative AI server 10 via the LAN/Internet 8. The RTC 211 has a clock function.

Connected to the sub system 221 are the printer device 4, the scanner device 2, the FAX device 7, and so forth. The sub system 220 is formed by a relatively small general-purpose sub-CPU system and image processing hardware. The sub system 220 includes a sub CPU 221, a memory 223, a bus controller 224, a non-volatile memory 225, an image processor 226, a printer controller 227, and a scanner controller 228.

The sub-CPU 221 controls the entirety of the sub system 220. Further, the sub-CPU 221 controls the FAX device 7. The memory 223 is used as a work memory of the sub-CPU 221. The bus controller 224 has a bridge function with an external apparatus. The non-volatile memory 225 is a storage device capable of storing data even after the sub system 220 is powered off. The image processor 226 performs real-time digital image processing. The printer controller 227 controls print processing by the printer device 4. For example, the printer controller 227 transmits image data to be printed to the printer device 4. The scanner controller 228 controls scan processing by the scanner device 2. For example, the scanner controller 228 issues a scan processing execution instruction to the scanner device 2, and acquires scan image data generated by the scan processing from the scanner device 2.

Here, the operation of the controller 3 will be described by taking an example of the copy function. When a user inputs an instruction for image copying from the console section 5, the main CPU 201 transmits an image reading instruction to the scanner device 2 via the sub-CPU 221. The scanner device 2 performs optical scanning of an original having been set thereon to convert the scanned image to scan image data, and transmits the scan image data to the image processor 226 via the printer controller 227. The image processor 226 temporarily stores the scan image data by performing direct memory access (DMA) transfer to the memory 223 via the sub-CPU 221.

When it can be confirmed that a predetermined amount of or all of the scan image data is stored in the memory 223, the main CPU 201 issues an image output instruction to the printer device 4 via the sub-CPU 221. The sub-CPU 221 notifies the image processor 226 of a storage area of scan image data in the memory 223. The scan image data stored in the memory 223 is transmitted to the printer device 4 via the image processor 226 and the printer controller 227 according to a synchronization signal output by the printer device 4. The printer device 4 prints the received scan image data on a sheet.

Note that in a case where a plurality of copies are printed, the main CPU 201 stores scan image data stored in the memory 223, into the storage device 6. Thus, by storing scan image data into the storage device 6, it is possible to transmit the scan image data for second and following copies of print, without acquiring the same from the scanner device 2 again.

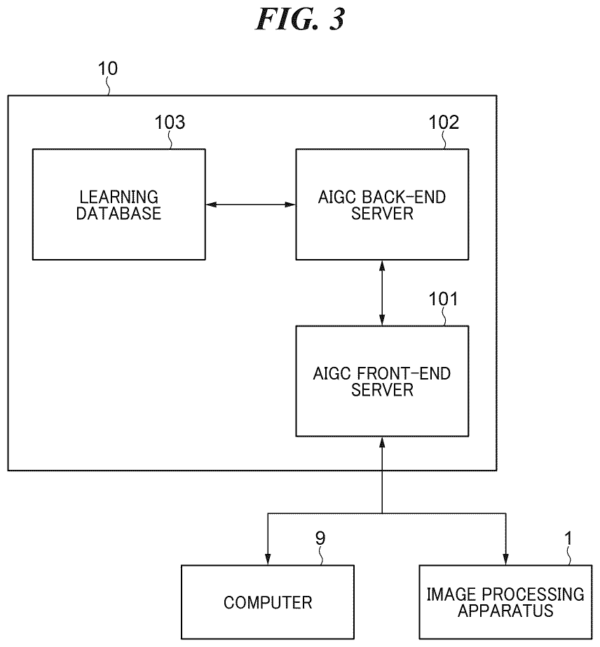

FIG. 3 is a block diagram schematically showing the configuration of the generative AI server 10 appearing in FIG. 1. Referring to FIG. 3, the generative AI server 10 includes an AIGC front-end server 101, an AIGC back-end server 102, and a learning database 103.

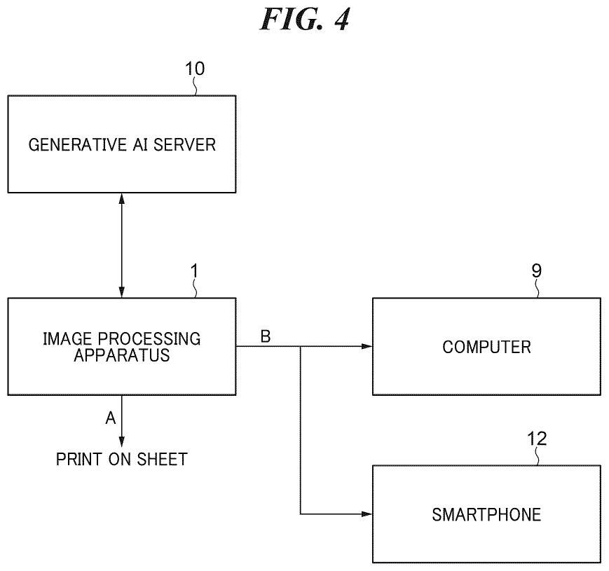

The AIGC front-end server 101 requests image generation to the AIGC back-end server 102 based on an image generation request received from an external apparatus, such as the computer 9 and the image processing apparatus 1. The AIGC back-end server 102 performs image generation processing using a learned model stored in the learning database 103 to generate AI image data. Further, the AIGC back-end server 102 transmits the generated AI image data to a transmission destination (the image processing apparatus 1, the computer 9 or the like) designated by the image generation request, via the front-end server 101. For example, in a case where image data is transmitted to the image processing apparatus 1, the image processing apparatus 1 prints the received image data on a sheet, as indicated by A in FIG. 4. Further, the image processing apparatus 1 transfers the received image data to another device, such as the computer 9 or a smartphone 12 appearing in FIG. 4, as indicated by B in FIG. 4. The learning database 103 stores the learned model learned such that t a colored realistic image is output from a line drawing.

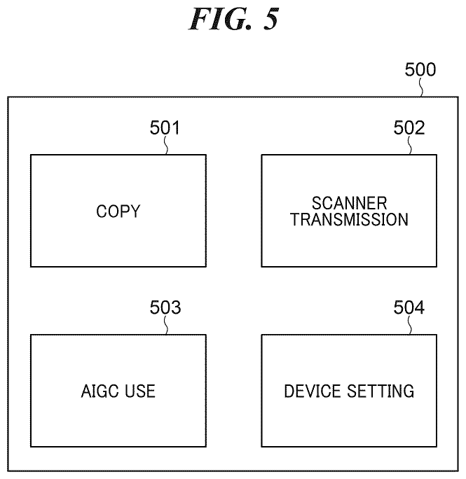

Next, the configuration of a user interface (UI) of the image processing apparatus 1 will be described. FIG. 5 is a diagram showing an example of a UI image screen 500 displayed on the console section 5 appearing in FIG. 1. On the UI screen 500, there are displayed a plurality of operation buttons associated with available functions of the image processing apparatus 1, including, for example, a copy button 501, a scan transmission button 502, an AIGC use button 503, and a device setting button 504. Note that the described configuration of the UI screen 500 is an example, and an operation button other than the above-mentioned buttons can be further included.

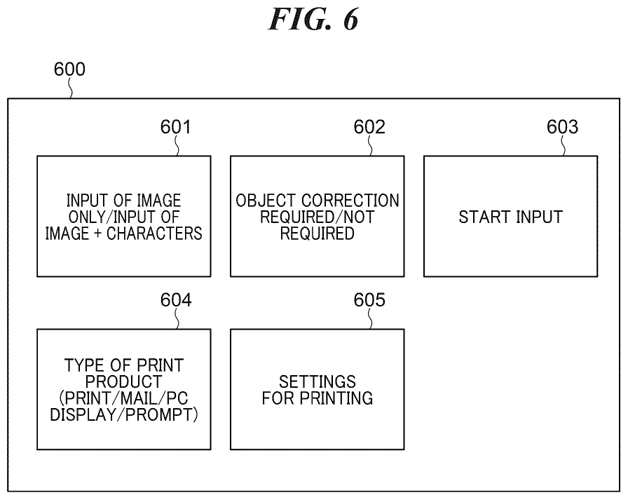

The copy button 501 is an operation button for using the copy function of the image processing apparatus 1. The scan transmission button 502 is an operation button for using the image transmission function of the image processing apparatus 1. The device setting button 504 is an operation button for making a variety of settings for the image processing apparatus 1. The AIGC use button 503 is an operation button for using the AIGC system of the present embodiment. When the user selects the AIGC use button 503, an AIGC application, not shown, which is installed in the image processing apparatus 1, is started, and a setting screen 600 shown in FIG. 6 is displayed on the console section 5. The setting screen 600 includes operation buttons 601 to 605.

The operation button 601 is a button for setting whether to use only an image or to use an image and characters, as an input to the AIGC system. For example, in a case where using only an image as an input to the AIGC system is set, the image processing apparatus 1 generates intermediate data based on an object identified from the generated scan image data, and transmits the intermediate data to the generative AI server 10 together with the image generation request. The intermediate data is a prompt formed by a character string of natural language expressing features of rough drawing. The prompt includes a character string (“person,” “cat,” or the like) indicating a type of an object, a character string (“center” or the like) indicating the position of the object included in the scan image data, and a character string (“manga-like fashion” or the like) indicating a style of AI image data. Note that the intermediate data is not limited to the prompt, but can be a command which can be interpreted as an instruction for generating realistic colored AI image data from the rough drawing by the generative AI server 10 and including feature information of an object included in the scan image data.

In a case where to use an image and a character as an input to the AIGC system is set, the image processing apparatus 1 generates intermediate data based on an object and character information which are identified from the generated scan image data. Further, the image processing apparatus 1 transmits the intermediate data to the generative AI server 10 together with an image generation request. For example, in a case where a character string of “manga-like fashion” is hand-drawn besides an object in the scan image data, the image processing apparatus 1 generates intermediate data including the character string of “manga-like fashion” as a character string of natural language expressing a feature of the object.

The operation button 602 is a button for making settings of object correction. When the user has enabled setting of object correction, if it is impossible to narrow down feature information of an object due to ambiguity of the rough drawing, the image processing apparatus 1 prompts the user to select feature information of an object from a plurality of assumable candidates thereof.

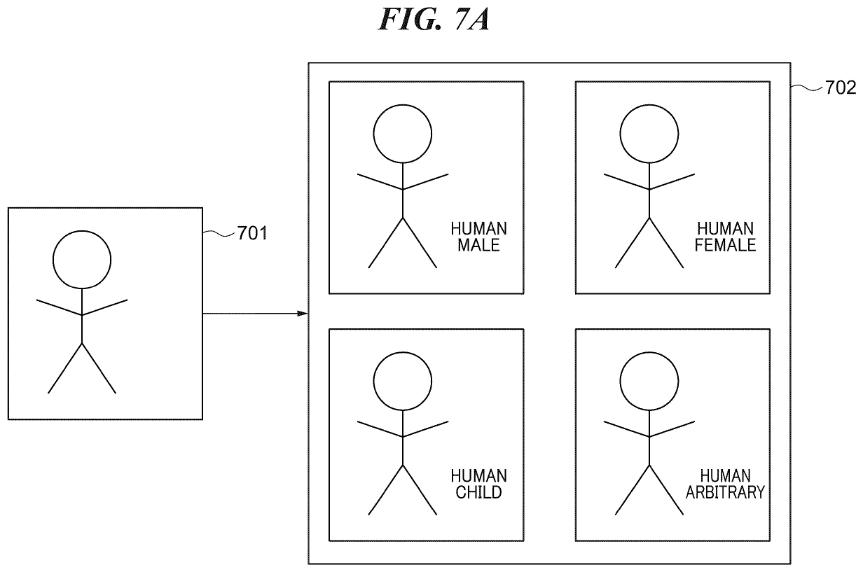

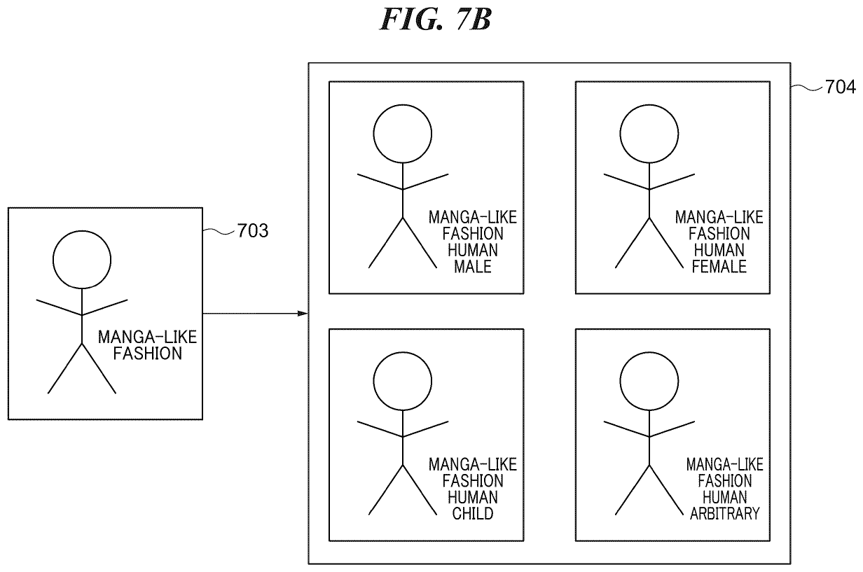

Here, a case of using only an image as an input to the AIGC system is set by the operation button 601 will be described. In this case, as shown in FIG. 7A, when an original 701 of rough drawing in which a background and a character are drawn is set on the image processing apparatus 1, the image processing apparatus 1 performs identification processing of an object included in the scan image data of the original. The image processing apparatus 1 can identify that an object included in the scan image data is a humane, but the rough drawing is ambiguous, and hence it is impossible to identify that the object is which of a male, a female, and a child. Therefore, the image processing apparatus 1 displays a selection screen 702 for prompting a user to select the feature information of an object from a plurality of assumable candidates thereof, on the console section 5. The image processing apparatus 1 generates intermediate data based on the feature information selected in the selection screen 702.

Further, in a case where to use an image and a character as an input to the AIGC system is set by the operation button 601, a selection screen is similarly displayed. For example, in a case where, as shown in FIG. 7B, the original, denoted by reference numeral 703, of rough drawing in which the character string of the manga-like fashion is drawn beside a person is set on the image processing apparatus 1, the image processing apparatus 1 performs identification processing of the object included in the scan image data of the original. The image processing apparatus 1 can identify that the object included in the scan image data is a humane, but since the rough drawing is ambiguous, and hence it is impossible to identify that the object is which of a male, a female, and a child. Therefore, the image processing apparatus 1 displays a selection screen 704 for prompting a user to select the feature information of an object from a plurality of assumable candidates thereof, on the console section 5. The image processing apparatus 1 generates intermediate data based on the feature information selected in the selection screen 704.

The operation button 603 is a button for performing an instruction for generating scan image data of the original by reading an original of rough drawing.

The operation button 604 is a button for making settings concerning a product. In the present embodiment, for example, it is possible to print AI image data generated by the generative AI server 10, and transmit the AI image data to the computer 9 operated by a user or the like. Further, it is possible to display the AI image data on the computer 9 or the like, and set whether or not to reuse a prompt as intermediate data.

The operation button 605 is a button for making print settings. When the operation button 604 is operated to set printing of the AI image data, the print settings used for print processing are set. For example, it is possible to make settings such that the AI image data is output in the form of a poster or a booklet.

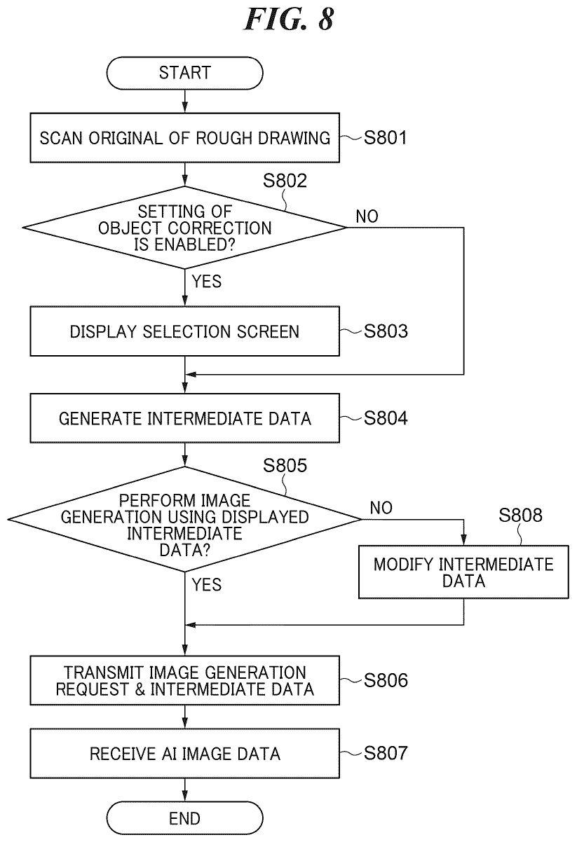

FIG. 8 is a flowchart of an AI image data generation control process performed by the image processing apparatus 1 appearing in FIG. 1. The AI image data generation control process is realized by the controller 3 executing a program stored in the memory 203, the memory 223, or the like. The AI image data generation control process is executed when the user selects the operation button 603 after setting an original of rough drawing on the image processing apparatus 1.

Referring to FIG. 8, first, the controller 3 scans the set original of rough drawing (S801). This generates scan image data of the original. Next, the controller 3 performs the identification processing of an object included in the generated scan image data. With this, the object, such as a person included in the scan image data, is identified. Further, in a case where to use an image and characters as an input to the AIGC system is set by the operation button 601, character information included in the scan image data is also identified.

Next, the controller 3 determines whether or not the settings of object correction are enabled (S802).

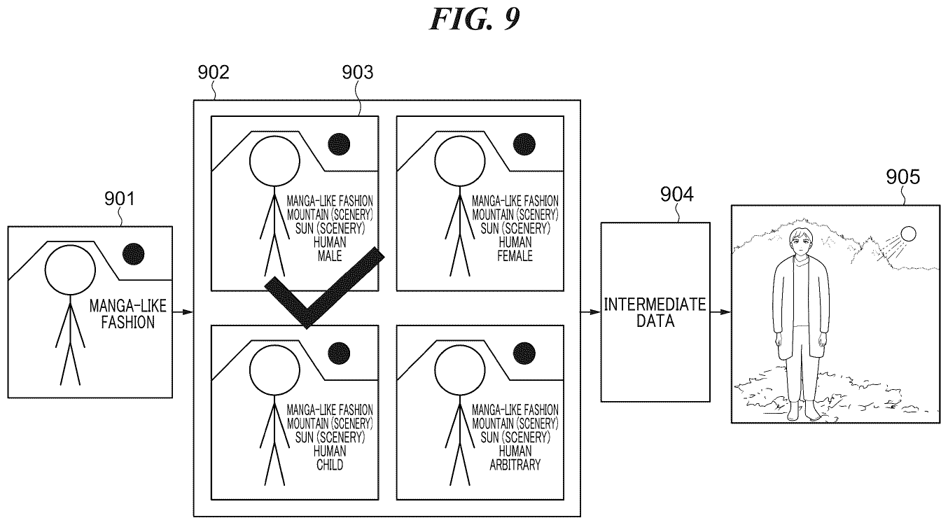

If it is determined in the step S802 that the settings of object correction are not enabled, the present process proceeds to a step S804. If it is determined in the step S802 that the settings of object correction are enabled, the controller 3 causes a selection screen for prompting a user to select the feature information of the object, to be displayed on the console section 5 (S803). Here, a description will be given of a case where an original 901 of rough drawing in which a person and a background are drawn and the character string of “manga-like fashion” is drawn beside the person is set, as shown in FIG. 9, by way of example. In the identification process of an object included in the scan image data of the original 901, the controller 3 can identify that the background and the person are drawn, but cannot identify that the person is which of a male, a female, or a child. For this reason, the controller 3 causes a selection screen 902 to be displayed on the console section 5, for prompting the user to select the feature information of the person from a plurality of candidates thereof. When the user selects one of the plurality of candidates included in the selection screen 902, the present process proceeds to the step S804.

In the step S804, the controller 3 generates intermediate data for causing the generative AI server 10 to generate an AI image. For example, in a case where settings of object correction are not enabled, the controller 3 generates intermediate data based on the feature information of the object identified by the identification process. Note that the intermediate data is a prompt formed by a character string of natural language representing features of the identified object. On the other hand, in a case where the settings of object correction are enabled, the controller 3 generates the intermediate data, denoted by reference numeral 904 based on the feature information, denoted by reference numeral 903, which is selected on the selection screen 902.

Next, the controller 3 causes the generated intermediate data to be displayed on the console section 5, and prompts the user to confirm whether or not to perform image generation using the intermediate data (S805).

If it is determined in the step S805 that the user has given an instruction for performing image generation using the intermediate data, the controller 3 transmits the intermediate data generated in the step S804 and the image generation request to the generative AI server 10 (S806). The generative AI server 10 performs the image generation process using the received intermediate data as an input. With this, AI image data 905, for example, is generated in which rough drawing drawn on the original 901 is drawn in a realistic and manga-like fashion. The generative AI server 10 transmits the generated AI image data 905 to a destination designated by the image generation request, for example, to the image processing apparatus 1.

Next, the controller 3 receives the AI image data 905 from the generative AI server 10 (S807). The controller 3 prints, for example, the received AI image data 905 on a sheet, as indicated by A in FIG. 4, referred to hereinabove, or alternatively, transmits the received AI image data 905, as indicated by B in FIG. 4, to an external apparatus, such as the computer 9 or the smartphone 12, followed by terminating the present process.

If it is determined in the step S805 that no instruction for performing the image generation using the intermediate data is received from the user, the controller 3 modifies the intermediate data according to a modification instruction received from the user (S808). Next, the controller 3 transmits the modified intermediate data and the image generation request to the generative AI server 10 in the step S806. Thereafter, the above-described step S807 is executed, followed by terminating the present process.

According to the embodiment described above, the generative AI server 10 is caused to generate AI image data based on the scan image data acquired by scanning an original. This makes it possible to cause information concerning a composition and information concerning a background, which are acquired from the scan image data, to be included in the instruction for image generation to the generative AI server 10, whereby it is possible to properly provide an instruction for image generation to the generative AI server 10.

Further, in the embodiment described above, an original includes an object hand-drawn by a user. With this, the user is capable of properly providing an instruction concerning a composition and an instruction concerning a background to the generative AI server 10 only by preparing an original in which an object is hand-drawn.

Further, in the embodiment described above, intermediate data including feature information of an object identified from scan image data is generated, and the intermediate data is transmitted to the generative AI server 10. This makes it possible to transmit the feature information of an object identified from the scan image data to the generative AI server 10.

Further, in the above-described embodiment, a selection screen is displayed on the console section 5, for prompting a user to select information included in the intermediate data, from among a plurality of candidates serving as feature information of the identified object. This makes it possible to cause an intention of the user to be reflected on the information included in the intermediate data.

Further, in the embodiment described above, in an original, a character string indicating a feature of the object is drawn beside the object, and intermediate data further includes the character string identified from scan image data. This enables the user to provide an instruction for image generation to the generative AI server 10, by combining a rough drawing and characters.

In the embodiment describe above, the intermediate data is edited by the user. This makes it possible to provide an instruction having a user's intention more properly reflected thereon to the generative AI server 10.

Further, in the embodiment described above, the received AI image data is printed. This makes it possible to acquire a print product of the AI image data caused to be generated by the generative AI server 10.

Further, in the embodiment described above, the generative AI is provided in the generative AI server 10 as an external apparatus different from the image processing apparatus 1. This makes it possible to properly provide an instruction for image generation to the generative AI server 10 as an external apparatus.

Note that in the present embodiment, the image processing apparatus 1 is not limited to an apparatus including the scan function. For example, the image processing apparatus 1 can be an apparatus equipped with an image capturing function, such as a smartphone, a tablet terminal, or a PC. The controller of an apparatus equipped with the image capturing function or an application installed in the apparatus performs processing for capturing an image of an original in rough drawing and generating captured image data of the original, and performs processing in the above-described steps S802 to S808 by using the generated captured image data. Thus, the apparatus equipped with the image capturing function as well can properly provide an instruction for image generation to the generative AI server 10.

Further, in the present embodiment, the image processing apparatus 1 can be configured to include a generative AI. With this, the image processing apparatus 1 including the generative AI is capable of properly providing an instruction for image generation to the generative AI.

Further, in the present embodiment, the processing for recognizing an object from scan image data or captured image data can be performed using an AI included in the image processing apparatus 1. In a recent CPU, a circuit dedicated to object recognition is integrated, in many cases. By using the CPU in combination with the circuit, it is possible to perform the processing for recognizing an object with high accuracy, while holding load of the processing to the minimum extent.

Further, in the present embodiment, the image processing apparatus 1 can cause the generative AI server 10 to generate the AI image data associated with the print settings. For example, in a case where a setting of 2 in 1 is made by print setting, the image processing apparatus 1 generates intermediate data for causing the generative AI server 10 to generate the AI image data in which two image data items are laid out. This makes it possible to provide an instruction for generating AI image data associated with the print settings to the generative AI server 10.

Further, in the present embodiment, in a case where the generative AI server 10 is configured to be capable of generating AI image data by using image data of rough drawing as an input, not the intermediate data, but the scan image data or the captured image data can be transmitted to the generative AI server 10 together with the image generation request. This enables the image processing apparatus 1 to properly provide an instruction for image generation to the generative AI server 10 without sparing resources thereof to generation of the intermediate data.

Note that the technique according to the present embodiment can be used, for example, in cases where a flowchart is generated, and generation of a poster (e.g. a person is sketched using lines to express a posture thereof by rough drawing and a character string of manga-like fashion is written beside the rough drawing to indicate a style of the rough drawing). Further, the technique can be used for generation of a prototype of slides, a New Year's card, a letter, a handbill, a magazine published by like-minded people, and the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
a reading unit configured to read an original;
a generation unit configured to cause generative AI to generate, based on first image data acquired by reading the original by the reading unit, second image data; and
a reception unit configured to receive the second image data generated by the generative AI.

2. The image processing apparatus according to claim 1, wherein the reading unit includes an image capturing unit configured to capture an image of the original, and
wherein the first image data is acquired by capturing the image of the original by the image capturing unit.

3. The image processing apparatus according to claim 1, wherein the original includes an object hand-drawn by a user.

4. The image processing apparatus according to claim 3, wherein the generation unit identifies the object from the first image data, generates intermediate data including feature information of the identified object, and transmits the intermediate data to the generative AI.

5. The image processing apparatus according to claim 4, further comprising a selection unit configured to prompt a user to select the feature information to be included in the intermediate data, from a plurality of feature information candidates of the identified object.

6. The image processing apparatus according to claim 4, wherein, in the original, a character string indicating a feature of the object is drawn beside the object, and
wherein the intermediate data further includes the character string identified from the first image data.

7. The image processing apparatus according to claim 4, further comprising an edit unit configured to prompt the user to edit the intermediate data.

8. The image processing apparatus according to claim 4, wherein the generation unit transmits the first image data to the generative AI.

9. The image processing apparatus according to claim 4, further comprising a printing unit configured to print the received second image data.

10. The image processing apparatus according to claim 4, wherein the generation unit causes the generative AI to generate the second image data associated with print settings made by the user.

11. The image processing apparatus according to claim 1, wherein the generative AI is included in an external apparatus different from the image processing apparatus.

12. The image processing apparatus according to claim 1, further comprising the generative AI.

13. A method of controlling an image processing apparatus, the method comprising:
reading an original;
causing generative AI to generate, based on first image data acquired by reading the original by the reading, second image data; and
receiving the second image data generated by the generative AI.

14. The method according to claim 13, wherein the reading includes capturing an image of the original, and
wherein the first image data is acquired by capturing the image of the original by the capturing.

15. A non-transitory computer-readable storage medium storing a program for causing a computer to execute a method of controlling an image processing apparatus, the method comprising:
reading an original;
causing generative AI to generate, based on first image data acquired by reading the original by the reading, second image data; and
receiving the second image data generated by the generative AI.

16. The storage medium according to claim 15, wherein the reading includes capturing an image of the original, and
wherein the first image data is acquired by capturing the image of the original by the capturing.
